(19) United States
(12) Patent Application Publication
(10) Pub. No.: US 2015/0348033 A1
(43) Pub. Date: Dec. 3, 2015

(54) Secure Payments Using Portable Communication Devices and Two Dimensional Codes

(71) Applicant: Leon Johannes BRITS, (US)

(72) Inventors: Leon Johannes Brits, Centurion (ZA); Stephen Boyd Robson, Pretoria (ZA)

(73) Assignee: Leon Johannes Brits, Centurion (ZA)

(21) Appl. No.: 14/653,911

(22) PCT Filed: Dec. 18, 2013
(86) PCT No.: PCT/IB2013/061085

§ 371 Date: Jun. 19, 2015

(30) Foreign Application Priority Data
Dec. 21, 2012 (ZA) 2012/09741

(51) Int. Cl. G06Q 20/40; G06Q 30/04

(52) U.S. Cl. CPC G06Q 20/405; G06Q 30/04

(57) ABSTRACT

Method and system for facilitating a transaction between a payor and a payee. The method involves, on a first portable communication device of a payee (12), receiving transaction data, generating a digitally signed invoice artefact incorporating the transaction data and displaying the digitally signed invoice artefact on a display of the payee's device (12). The method then involves, on a second portable communication device of a payor (10), capturing an image of the displayed digitally signed invoice artefact and extracting the transaction data, displaying the transaction data on a display of the payor's device (10), receiving a user input confirming the correctness of the transaction data and transmitting the transaction data securely to a verification centre (16), generating a digitally signed confirmation artefact, and displaying the digitally signed confirmation artefact on the display of the payor's device (10). The method further involves, on the first payee's device (12), capturing an image of the displayed digitally signed confirmation artefact, and transmitting the transaction data securely to the verification centre (16) to confirm the transaction.

### BACKGROUND OF THE INVENTION

THIS invention relates to a method and system for facilitating a transaction between two parties.

The use of mobile devices such as mobile telephones in carrying out financial transactions is now well established. However, the take-up of such technology has been limited. One reason for this may be the fact that customers and merchants are familiar with conventional transaction methods in which the merchant generates an invoice which is presented to the customer for perusal and confirmation.

It is an object of the invention to provide an alternative method and system for utilising mobile communication devices in such transactions.

### SUMMARY OF THE INVENTION

According to a first aspect of the invention there is provided a method of facilitating a transaction between a payor and a payee, the method including the steps of:
on a first portable communication device of a payee, receiving transaction data, generating a digitally signed invoice artefact incorporating the transaction data and displaying the digitally signed invoice artefact on a display of the first portable communication device;
on a second portable communication device of a payor, capturing an image of the displayed digitally signed invoice artefact and extracting the transaction data therefrom, displaying the transaction data on a display of the second portable communication device, receiving a user input confirming the correctness and acceptance of the transaction data and transmitting the transaction data securely to a verification centre, generating a digitally signed confirmation artefact, and displaying the digitally signed confirmation artefact on the display of the second portable communication device; and
on the first portable communication device, capturing an image of the displayed digitally signed confirmation artefact, and transmitting the transaction data securely to the verification centre to confirm the transaction.

Once the secure communications from both devices have been received and verified at the verification centre, the verification centre instructs a financial institution to transfer funds from the payor to the payee.

The transaction data may relate to a commercial transaction wherein the payor is a customer or client, and the payee is a merchant or service provider.

Alternatively the payor and payee may be any parties conducting a transaction involving the transfer of funds from one to the other.

Each of the invoice artefact and the confirmation artefact may be a two dimensional code.

Preferably, the two dimensional code contains at least the transaction data, a digital signature and a digital certificate.

According to another aspect of the invention there is provided a system for carrying out the method of facilitating a transaction between a payor and a payee, the system including:
at least one first portable communication device of a payee;
at least one second portable communication device of a payor; and
a verification centre for communicating securely with a bank or clearing house and for controlling a transaction between the first and second portable communication devices of the payor and the payee,
   wherein each mobile communication device includes a processor, a software application arranged to run on the processor to process the transaction and create secure artefacts, a display, data entry means, and an imaging device, the first portable communication device being operable to receive transaction data, to generate a digitally signed invoice artefact incorporating the transaction data and to display the digitally signed invoice artefact on the display of the first portable communication device; the second portable communication device being operable to capture an image of the displayed digitally signed invoice artefact and to extract the transaction data therefrom, to display the transaction data on the display of the second portable communication device, to receive a user input confirming the correctness and acceptance of the transaction data and to transmit the transaction data securely to the verification centre, to generate a digitally signed confirmation artefact, and to display the digitally signed confirmation artefact on the display of the second portable communication device; the first portable communication device further being operable to capture an image of the displayed digitally signed confirmation artefact and to transmit the transaction data securely to the verification centre to confirm the transaction.

Each of the first and second portable communication devices may be, for example, a mobile telephone, a tablet computer, or a notebook or laptop computer.

Preferably, each of the invoice artefact and the confirmation artefact is a two dimensional code.

In a preferred example embodiment, the two dimensional code contains at least the transaction data, a digital signature and a digital certificate.

### BRIEF DESCRIPTION OF THE DRAWINGS

FIG. 1 is a simplified schematic diagram illustrating a system for facilitating a transaction between two parties according to an example embodiment of the invention;

FIG. 2 is a simplified schematic block diagram of a communication device useable in the system of FIG. 1;

FIG. 3 is a flowchart showing major steps in a method of carrying out a financial transaction between a client and a merchant at a point of sale using the method and system of the invention; and

FIG. 4 is a simplified flowchart showing major steps in a transaction between two persons using the method and system of the invention.

### DESCRIPTION OF EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

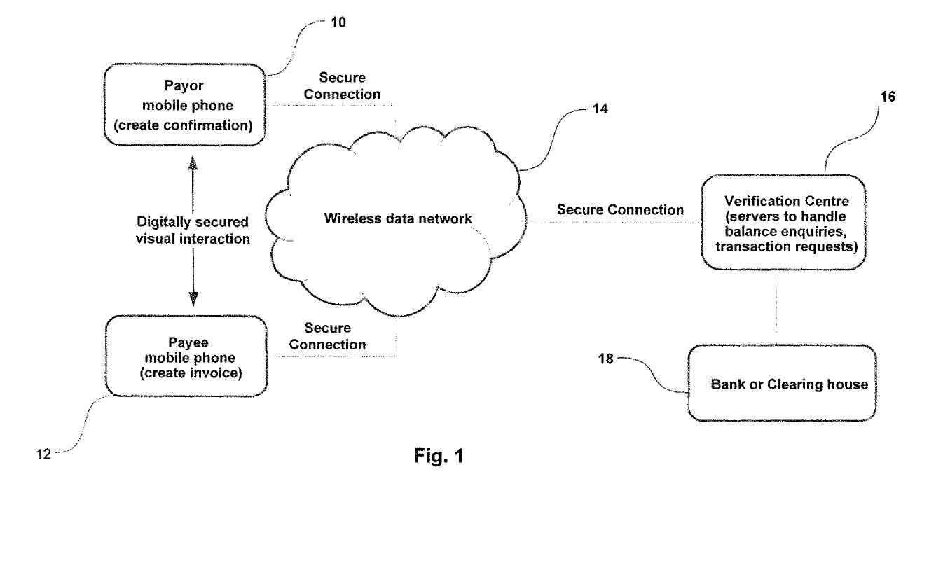

The simplified system diagram of FIG. 1 shows a payor 10 and a payee 12 who engage in a financial transaction. Typically, the payor is a customer or a client and the payee is a vendor or merchant or other supplier of goods or services to the customer.

According to the present invention, both the payor and the payee make use of a portable communication device, typically a mobile telephone, as a transaction terminal. The devices of the payor and payee are each connected by a wireless connection to a wireless data network 14, over which they are able to make secure, mutually authenticated connections to the verification centre. The network 14 may consist of one or more networks, including a Wi-A network, a GSM telephone network, or a wireless mobile data network such as a 3G or better network.

From the wireless data network 14, via a secure connection, the devices of the payor and payee connect to a verification centre 16 which operates to manage the transaction between the payor and the payee and to communicate with a bank or clearing house 18 through which the actual payment between the parties is made.

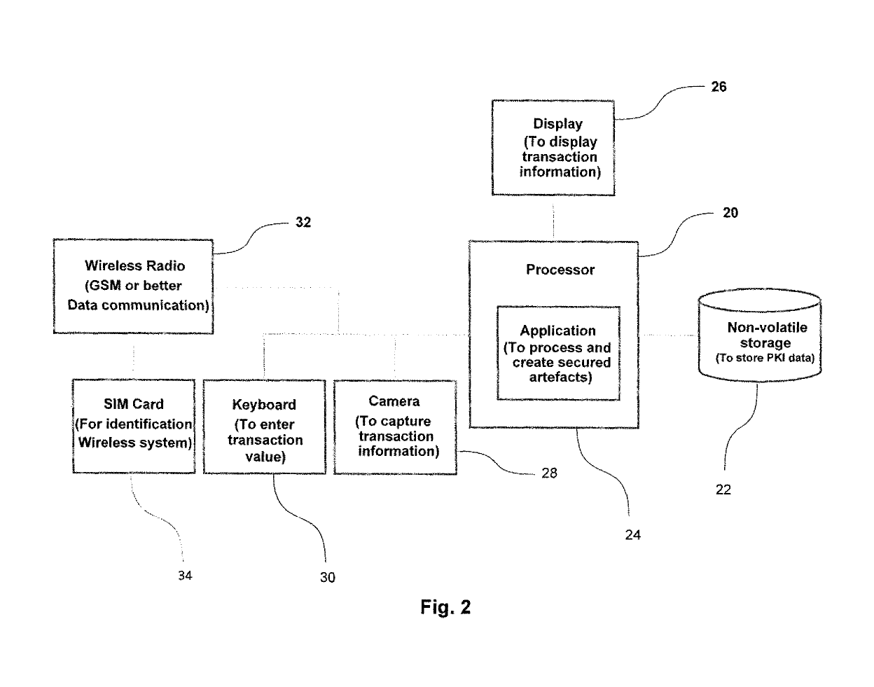

FIG. 2 shows major components of one of the mobile communication devices in greater detail. Typically, the mobile communication device is a mobile telephone (typically a smartphone) but could also be a tablet computer, a laptop/notebook computer or any other mobile communication device with the required functionality.

The mobile communication device has a processor 20 with associated non-volatile storage 22 for storing the necessary software and security data to operate the method. The processor includes volatile storage (Le. RAM) which is used in operation. The software includes an application 24 which runs on the processor 20 to process the transaction and create the necessary secure artefacts, as described below.

The mobile communication device includes a display 26 which is used to display transaction information, and a camera 28 or other imaging device which is used to capture transaction information in carrying out the method. The device also includes a keyboard or keypad 30 which is used to enter a transaction value and other data.

Finally, the mobile communication device includes a wireless radio 32, typically a GSM radio, and an associated subscriber identity module (SIM) 34 which is used for secure identification of the device.

To be able to use the method and system of the invention, both the payor and the payee subscribe to the system and create accounts. The necessary identification information and bank account details are recorded and stored on the devices or at the verification centre. Each installs the application 24 on their respective mobile communication devices and initiates a registration process to create PKI information for each particular device. The verification centre 16 is set up to communicate securely with the bank or clearing house 18 and controls the transaction between the devices of the payor and the payee.

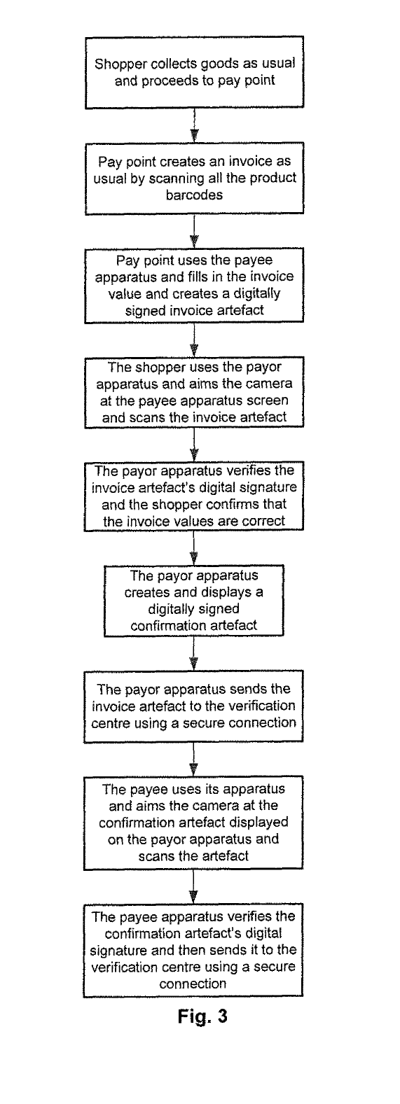

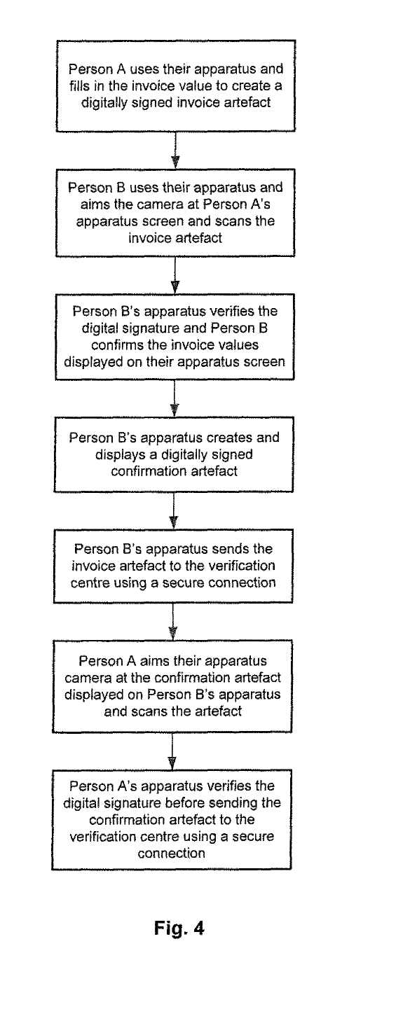

When a transaction takes place between the payor and payee, typically a point of sale transaction as illustrated by the flowchart of FIG. 3, or a transaction between persons as shown in the flowchart of FIG. 4, the payee's apparatus first generates a digitally signed invoice artefact which is based on the final transaction value, and displays this artefact on the display 26 of the payee's wireless communication device. The transaction value is entered into the payee's device via the keyboard 30. The displayed invoice artefact is typically a two dimensional code such as a QR Code. The two dimensional code contains at least the transaction information, a digital signature and optionally a digital certificate.

By means of the application 24 running on the processor 20 of the payor's device this device is then used to photograph the displayed invoice artifact using the camera 28 of the payor's device. The invoice artifact image is parsed and its authenticity and integrity are confirmed by means of the digital signature before the relevant invoice data is displayed on the display 26 of the payor's device.

The payor's device then establishes a mutually authenticated secure connection with the verification centre 16 via the wireless data network 14, and uploads the invoice data to the verification centre. The verification centre communicates with the bank or clearing house 18 to verify that the funds required to conclude the transaction are available in the selected account. If the verification centre responds positively and the invoice data is accepted by the payor, then the application 24 running on the processor 20 of the payor's device generates and displays a digitally signed confirmation artefact on its display 26.

The payee's apparatus is then positioned so as to photograph, by means of the application 24 running on the processor 20 of the payee's device, the confirmation artefact displayed on the payor's device using the camera 28 of the payee's device. The application 24 parses the confirmation artifact and confirms the artefact's authenticity and integrity by means of the digital signature. Once this has been done, the payee's device securely transmits the artefact information to the verification centre. The verification centre verifies the integrity of all received invoices and confirmations by means of their digital signatures and matches invoices to their respective confirmations to determine complete transactions before communication with the bank or clearing house to request that the relevant funds be transferred.

The use of invoice and confirmation artefacts which are digitally signed and displayed on a first device for scanning or photographing by a second device provides substantial security improvements compared with known systems which do not make use of such directed methods. The visual interaction between the cameras and displays limits the flow of information to the payor and payee only, while the digital signature ensures the authenticity and integrity of the information and makes the transaction non-repudiable and non-repeatable.

In addition, in known systems using portable communication devices to conduct transactions, the transaction is generally completed with the client connecting directly to the bank. In the case of the present invention, an extra step is included which requires the vendor to receive and approve a confirmation from the client before the transaction is completed. For this reason the transaction “feels” similar to a standard money exchange transaction.

1. A method of facilitating a transaction between a payor and a payee, the method including the steps of:
on a first portable communication device of a payee, receiving transaction data, generating a digitally signed invoice artefact incorporating the transaction data and displaying the digitally signed invoice artefact on a display of the first portable communication device;
on a second portable communication device of a payor, capturing an image of the displayed digitally signed invoice artefact and extracting the transaction data therefrom, displaying the transaction data on a display of the second portable communication device, receiving a user input confirming the correctness and acceptance of the transaction data and transmitting the transaction data securely to a verification centre, generating a digitally signed confirmation artefact, and displaying the digitally signed confirmation artefact on the display of the second portable communication device; and
on the first portable communication device, capturing an image of the displayed digitally signed confirmation artefact, and transmitting the transaction data securely to the verification centre to confirm the transaction.

2. The method of claim 1 wherein, once the secure communications from both devices have been received and verified at the verification centre, the verification centre instructs a financial institution to transfer funds from the payor to the payee.

3. The method of claim 1 wherein the transaction data relates to a commercial transaction wherein the payor is a customer or client, and the payee is a merchant or service provider.

4. The method of claim 1 wherein the payor and payee are any parties conducting a transaction involving the transfer of funds from one to the other.

5. The method of claim 1 wherein each of the invoice artefact and the confirmation artefact is a two dimensional code.

6. The method of claim 5 wherein the two dimensional code contains at least the transaction data, a digital signature and a digital certificate.

7. A system for carrying out a method of facilitating a transaction between a payor and a payee, the system including:
at least one first portable communication device of a payee;
at least one second portable communication device of a payor; and
a verification centre for communicating securely with a bank or clearing house and for verifying a transaction between the payor and the payee,
wherein each mobile communication device includes a processor, a software application arranged to run on the processor to process the transaction and create secure artefacts, a display, data entry means, and an imaging device, the first portable communication device being operable to receive transaction data, to generate a digitally signed invoice artefact incorporating the transaction data and to display the digitally signed invoice artefact on the display of the first portable communication device; the second portable communication device being operable to capture an image of the displayed digitally signed invoice artefact and to extract the transaction data therefrom, to display the transaction data on the display of the second portable communication device, to receive a user input confirming the correctness and acceptance of the transaction data and to transmit the transaction data securely to the verification centre, to generate a digitally signed confirmation artefact, and to display the digitally signed confirmation artefact on the display of the second portable communication device; the first portable communication device further being operable to capture an image of the displayed digitally signed confirmation artefact and to transmit the transaction data securely to the verification centre to confirm the transaction.

8. The system of claim 7 wherein each of the first and second portable communication devices is a mobile telephone, a tablet computer, or a notebook or laptop computer.

9. The system of claim 7 wherein each of the invoice artefact and the confirmation artefact is a two dimensional code.

10. The system of claim 9 wherein the two dimensional code contains at least the transaction data, a digital signature and a digital certificate.
